(19) United States
(12) Patent Application Publication
(10) Pub. No.: US 2005/0278114 A1
(43) Pub. Date: Dec. 15, 2005

(54) Method and system for selecting destinations

(76) Inventor: Ahmad M. Ahmad, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 11/102,665

(22) Filed: Apr. 11, 2005

Related U.S. Application Data
(60) Provisional application No. 60/579,322, filed on Jun. 15, 2004.

(51) Int. Cl. G01C 21/30

(52) U.S. Cl. 701/211; 340/995.24

(57) ABSTRACT

An example information system contains records of landmarks. The system obtains records of taxi trips between the landmarks and from the taxi trip information derives statistical relationships between the landmarks. A user can provide context information, such as an address or a type of activity. The user can then search the system for landmarks of interest to the user. The system retrieves and presents the user with a set of landmarks which match the user's query based in part on the statistical relationships.

### CROSS REFERENCE TO RELATED APPLICATION

This application claims the benefit of U.S. application No. 60/579,322 filed on 15 Jun. 2004 and entitled METHOD AND SYSTEM FOR MODELLING PEOPLE TRAVELLING BEHAVIOUR.

### FIELD OF THE INVENTION

This invention relates to computer-based systems for providing users with information about available destinations. Some embodiments of the invention provide systems for providing information about tourist attractions and other amenities of interest to travelers and tourists.

### BACKGROUND

A visitor to a region is faced on an ongoing basis with the problem of deciding what to see and do. For example, a city can be considered to be a collection of public buildings or places such as restaurants, theaters, museums, galleries, parks, hotels, resorts, scenic locations, and the like that potentially attract people.

The visitor may obtain a guidebook which lists various landmarks. However, guidebooks have the problem that they become outdated. Further, different guidebook authors may choose to recommend, or not recommend, certain landmarks based upon their own subjective evaluation of those landmarks or even, in some cases, based on their own commercial interests. Finding the best landmarks can be a hard problem.

Online tourist information systems have become popular in recent years. A typical tourist information system allows users to search or browse an online list of landmarks and provides various information about the landmarks. The information may include descriptions, hours of operation, prices, location, and so on.

Many online tourist information systems permit tourists to conduct searches for landmarks based upon criteria such as type of landmark, price and location. However, such systems do not typically give a user:
a reliable sense about the relative importance of different landmarks;
a sense of when the landmarks are busiest; and so on.
   Such tourist information systems provide little or no customer rating and feedback information. Where such information is provided, the information may reflect feedback from only a few percent of customers and is often unreliable.

Taxis are a common mode of transportation in many cities. A taxi trip is marked with two address points. The first point is the place where a passenger is picked up and depicts the start of the trip (referred to herein as the “pickup point”). The second address is the place where the passenger is dropped off and represents the end of the trip (referred to herein as the “drop off point”).

Many taxi companies operate computerized dispatch systems. The dispatch systems keep track of the trips on which cabs have taken their customers including information identifying pickup and drop off points. The systems keep track of billing information and the like.

There remains a need for systems that can be used by visitors to an area to identify and select landmarks that they may want to visit.

### SUMMARY OF THE INVENTION

One aspect of this invention provides methods for identifying landmarks which may be of interest to a user based, at least in part, on an analysis of large numbers of taxi trips. Such an analysis may be used to model the patterns in which people travel among landmarks. The analysis can provide information such as:
how frequently are certain landmarks visited by taxi patrons as a function of time;
how frequently are certain landmarks visited by taxi patrons who embark from a certain area;
when are certain landmarks likely to be most and least crowded;
when are certain areas likely to be more busy or less busy;
how long does it take to travel through certain parts of a city as a function of time;
what is the expected cab fare between certain landmarks as a function of time;
what is the trip length (i.e. the street distance) between certain landmarks by way of the routes traveled by cab drivers;
and so on.

The invention provides a method for operating an automated system for providing information about landmarks. The method comprises providing statistical information about relationships between a plurality of landmarks. The statistical information is derived at least in part from records of taxi trips originating, ending, or both originating and ending at landmarks of the plurality of landmarks. The method receives a request for a search of landmarks matching a set of search criteria. In response to the request, the method retrieves a set of landmarks matching the search criteria and, ranks the set of landmarks retrieved by the search at least in part on the basis of the statistical information.

The invention also provides a method for automatically retrieving a set of landmarks of potential interest to a user. The method comprises receiving from the user type information identifying a category of landmarks of interest and context information directly or indirectly specifying at least one location. The method retrieves from a database a set of landmarks of the category indicated by the type information and ranks the landmarks of the set of landmarks based on the frequency with which taxi passengers have historically traveled between the at least one location of the context information and the landmarks of the set of landmarks.

In some embodiments of the invention, the statistical information includes information about sequences of taxi trips taken by individual taxi patrons. In some such embodiments of the invention, the method involves finding sets of landmarks of specified categories which are commonly linked by taxi trips taken by the same passenger. As an example, a user can conduct a search for the restaurants and entertainment-related landmarks for which taxi patrons most frequently take a first taxi trip from a given location to the restaurant and a second taxi trip from the restaurant to the entertainment-related landmark. As another example, a user may search for restaurants commonly visited by patrons of a hotel. After selecting a restaurant from the resulting set of restaurants the user might query the system to see where do taxi patrons who have traveled to the restaurant from the hotel typically go to after visiting the restaurant. This may produce a list of entertainment-related landmarks which are conveniently accessible by cab from the restaurant.

Another aspect of the invention provides landmark information systems which, at least in part, use data derived from one or more databases containing information about taxi trips to identify and/or rank landmarks which match a user's query. Some such systems continually collect information about taxi trips from one or more taxi operators, and preferably a plurality of taxi operators.

The invention provides a computerized landmark information system comprising a data store storing information about a plurality of landmarks and statistical information about relationships between the plurality of landmarks, the statistical information derived at least in part from records of taxi trips originating, ending, or both originating and ending at landmarks of the plurality of landmarks. The information system also comprises a search engine for conducting searches for sets of landmarks of the plurality of landmarks which match search criteria and means for ranking sets of landmarks retrieved by the search engine based at least in part on the statistical information.

Further aspects of the invention and features of various example embodiments of the invention are described below.

### BRIEF DESCRIPTION OF THE DRAWINGS

In drawings which illustrate non-limiting embodiments of the invention:

FIG. 1 is a schematic diagram showing major components of an information system according to a preferred embodiment of the invention;

FIG. 2 shows an exemplary database schema;

FIG. 3 is a schematic view of major modules the application server of the system of FIG. 1;

FIG. 4 illustrates a validation process;

FIG. 5 shows time slots in a one week cycle;

FIG. 6 is a flowchart illustrating a method for acquiring taxi data from a plurality of taxi databases;

FIGS. 7A and 7B illustrate an example flow of information from a plurality of taxi databases into a main database;

FIG. 8 is a block diagram showing functional aspects of a search server;

FIG. 9 is a flowchart illustrating a method for processing queries;

FIG. 10 is a diagram illustrating an interface for entering queries into a landmark information system;

FIG. 11 is an example of a search result set presented in a list format;

FIG. 12 is an example of a search result set presented in a chart format;

FIG. 13 is an example of a search result set presented in a map format; and,

FIG. 14 is a block diagram of a system according to an alternative embodiment of the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

Various terms used herein have special meanings. The terms “landmark” and “destination” are used herein as general terms which refer to a place that a person might be interested in going to. Restaurants, bars, theaters, museums, hotels, motels, shopping malls, stores, buildings, neighborhoods, districts, zoos, arenas, sports venues, tourist attractions, parks, beaches, and places of worship are all examples of landmarks. A landmark may be composed of several other landmarks. For instance, a neighborhood is a composite landmark that may include a number of atomic landmarks such as hotels and restaurants.

The term “taxi trip” refers to a one-way taxi (taxicab) journey for one or more passengers. The term taxi includes dispatched vehicles such as limousines, common taxicabs and the like. Each taxi trip has two endpoints: a pickup point and a drop off point. Each endpoint can be potentially identified in a variety of functionally equivalent ways. For example, an endpoint may be identified by one or more of:
a landmark name;
street name and zip code;
street name and street number (address);
street name, street number and unit number;
zip code;
GPS coordinates;
an intersection of two streets,
or the like.

“Pickup time” is a time scheduled for a passenger to be picked up. “Boarding time” is the time the passenger gets in the taxi. Boarding time is typically either equal to or later than the pickup time. “Drop off time” is the time when the passenger leaves the taxi at the drop off point.

A record of a taxi trip is a collection of information about a taxi trip which is accessible to a computer system. A record of a taxi trip may contain various information about the taxi trip. For example, the record may contain information such as:
the pickup point,
the drop off point,
the pickup time,
the boarding time,
the drop off time,
a specific cab identifier,
various attributes for the taxi requested by the passenger (for example, the type and the size of the taxi vehicle, and other options such as car phone, ski racks, and handicapped accessories),
various attributes for the taxi driver requested by the passenger, such as preferred language spoken by driver, and smoking status, passenger information, such as a number of passengers, names, ages, sex, phone numbers, and their work or home addresses,
billing information, and so on.
   The computer systems operated by taxi companies typically include records of at least most taxi trips taken by customers of the taxi company.

The term “trip path” is a chronological sequence of taxi trips taken by the same passenger. A trip path is not interrupted by any long periods in which the passenger does not take any taxi trips. Subsequent trips in a trip path all begin within a time period such as 24 hours, 8 hours, 4 hours or the like from the end of the previous trip in the trip path. The trip path represents the passenger's movements by taxi over time. A trip path has a length t, where trepresents the number of taxi trips in the trip path. For instance, if t=1 then the trip path contains only one taxi trip. If t=2 then the trip path contains two taxi trips, and so on.

The term “user” means a person who accesses a system according to the invention to obtain information relating to one or more landmarks. A user may be a traveler, tourist, local resident, or anyone else who uses a system.

The terms “include” and “comprise,” as well as derivatives thereof, mean inclusion without limitation.

Despite the apparent randomness of individual peoples' movements within a city or other area, visits to landmarks by people have a well-defined statistical structure. Each landmark l has a certain probability p, of being visited by a person. The probability typically varies with time. For example, the probability that a restaurant will be visited is typically highest just before typical meal times. The inventor has determined that information about large numbers of taxi trips can be analyzed to provide insights into the movements of people among landmarks. This information, in turn, can be relevant to people who are trying to select or rank landmarks to visit.

A collection of a large number of records of taxi trips can be analyzed to obtain statistical information about the visits of people to landmarks. Such statistical information can include:
the probability that a taxi passenger will visit a particular landmark,
the probability that a passenger at one landmark will travel to a second landmark,
the rates at which taxi passengers arrive at and/or leave a landmark as a function of time,
and so on.

In various embodiments of this invention such statistical information derived from records of taxi trips is used to help people to make decisions about where and when to go next. In essence, this statistical information provides a guide to understand people's traveling behavior and can be used to identify the relationships and relevance between different landmarks.

Architecture of an Example System

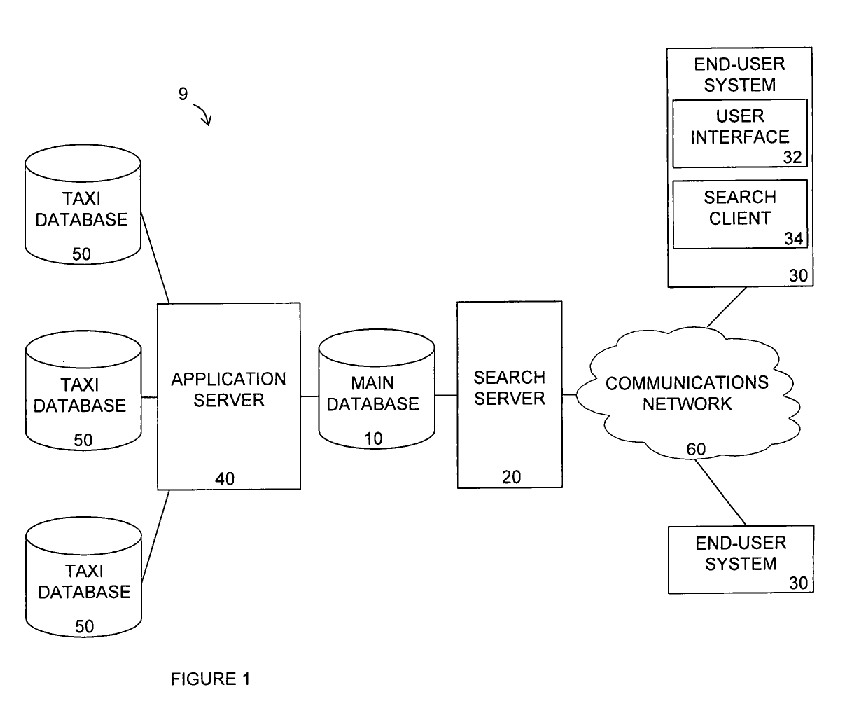

The invention will now be described with reference to an example information system. FIG. 1 is a schematic diagram showing major components in an information system 9 according to an embodiment of the invention. System 9 comprises a database 10, a search server 20, an end-user system 30, an application server 40, and a taxi database 50. Taxi database 50 contains records of taxi trips.

Database 10 is in data communication with search server 20 and application server 40 via a suitable data path. The data path will typically be provided by a communication network such as the internet, an intranet, a WAN, a LAN etc. Application server 40 and taxi database 50 are interconnected by way of a suitable data path. The data path may also be provided by a communication network and may comprise, for example, a virtual private network, a dedicated link, a public-switched telephone network (PSTN), or by another suitable data path.

Search server 20 and end-user system 30 are interconnected by a suitable data path which, in the illustrated embodiment, is carried by a communications network 60. The physical layer of communications network 60 may involve any suitable wired, fiber, or wireless data communication technology, or some combination thereof. Data may travel across network 60 by way of an arbitrary number of intermediate hops, which are not shown. Data link and network layers of communications network 60 may utilize any suitable protocol(s), for example, one or more local area network and wide area network data communication protocols such as Ethernet, Token-Ring, Fiber Distributed Data Interface, Asynchronous Transfer Mode, Frame Relay, Multiprotocol Label Switching, Internet Protocol (IP) and Internet Packet Exchange.

Although FIG. 1 illustrates five interconnected nodes, namely, database 10, search server 20, end-user system 30, application server 40, and taxi database 50, it will be appreciated that each of these five nodes may be interconnected to an arbitrary number of other nodes which are not shown. Two or more of the nodes may be hosted in the same computer system in some embodiments of the invention.

End-User System

End-user system 30 may comprise a workstation, desktop computer, notebook computer, cell phone, personal data assistant, kiosk, or any other suitable computing device. End-user system 30 includes a user interface 32 and a search client 34. User interface 32 is a display for viewing textual and graphical information including search results. Search client 34 typically comprises a software application, such as a general purpose web browser, for facilitating information exchange between end-user system 30 and search server 20 and for facilitating the display of information originating from search server 20 on user interface 32.

A user may enter a search request at end user system 30. End user system 30 generates search queries from the user's search requests, transmits the queries to search server 20 and receives search results from search server 20. In one embodiment, in which end user system 30 includes a general purpose web browser, generating search queries includes generating from search information accepted on user interface 32 Uniform Resource Identifies (URIs), as defined in Internet Engineering Task Force (IETF) Request for Comment (RFC) 2616, and encapsulating URIs in Hypertext Transfer Protocol (HTTP) GET requests, as defined in IETF RFC 2396. In this embodiment, transmitting search queries includes transmitting HTTP GET requests. Receiving search results includes accepting result information from search server 20. Facilitation of information viewing includes facilitating display of result information on user interface 32.

Main Database

Database 10 typically comprises a relational database management system (RDBMS) running on a suitable computer system. In this case, database 10 includes a number of tables having entries, or records, that are linked by indices and keys for storing statistical interrelationships between landmarks as revealed by taxi data.

Statistical relationships between a number of landmarks may be represented in database 10 by a finite-context model. In such a model, the chance that a person will travel to a particular landmark depends on a context consisting of a finite number (zero or more) of landmarks visited previously by that person. A context model may be an order-m fixed model in which the probability determination is based on a fixed number, m, of previous landmarks, or may be an order-m mixed model based on contexts with a maximum-length of m. In an order-m mixed model the contexts may include contexts of a plurality of different lengths.

An order-m fixed model can be specified by the finite set L consisting of q landmarks lᵢ (where each element lᵢ is a landmark) and the set of conditional probabilities:
pr(lᵢ|lⱼ_{₁},lⱼ_{₂}, . . . ,lⱼ_{ₘ}) for i=1,2, . . . ,q; jₚ=1,2, . . . ,q (1)

Where pr is the conditional probability of traveling to landmark lᵢ, given the sequence of landmarks lⱼ_{₁}, lⱼ_{₂}, . . . ,lⱼ_{ₘ}. For instance, if m=0 then no context is used and the probability of a landmark is the probability of its occurrence in set L. If m=1 then the previous landmark is used to determine the probability of the new landmark. If m=2 then the previous two landmarks are used, and so on.

A mixed model may be either fully or partially mixed. A model is fully mixed if it contains all the fixed submodels whose orders are equal to or less than the order of the model. That is, a fully mixed model with m=3 bases its determination on submodels of orders 3, 2, 1, and 0. A model is partially mixed if it uses some, but not all, of the submodels.

The order m of a model alters how well the model models the actual probability distribution of a collection of landmarks. Let us consider the behavior of a model as m equals to zero and then m gets larger. When m=0, the probability of a landmark is just the probability of its occurrence in the set. An order-0 model assumes that there is no dependency among landmarks. As m increases, it reflects better the actual dependency among landmarks. However, if m gets very large, the dependence of a landmark on the previous m landmarks becomes very weak. Thus, an order of few landmarks is very reasonable to determine the dependency among the landmarks.

The largest order of the context models is limited by the maximum length of trip path t that can be tracked. For instance, if t=1, order-1 is the largest model possible. If t=2, order-2 is the largest model possible, and so on. Taxi trips of a passenger may be tracked using a combination of passenger name and passenger phone number, or profile number in the case that the passenger has a profile predefined in database 50.

In an exemplary embodiment, the statistical relationships between landmarks are represented in a full mixed order-1 context model. This is preferred because of its space and time effectiveness. Moreover, using an order-1 model does not require tracking passengers across multiple taxi trips. The identities of passengers can remain anonymous to the system.

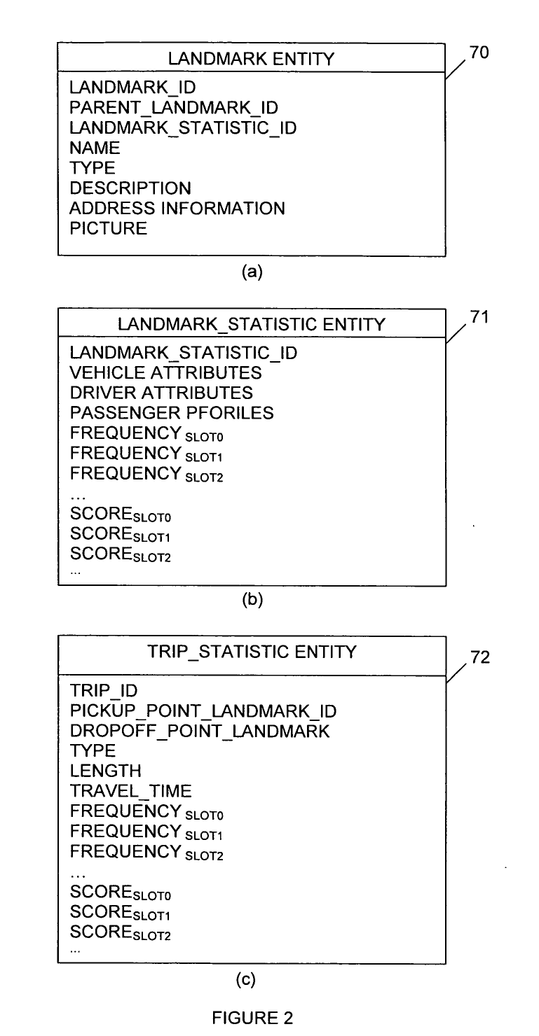

FIG. 2 shows an exemplary database schema of database 10. This schema is provided solely to facilitate understanding of the invention and is not provided to limit the scope of the invention. Those skilled in the art of database design will understand that any of a wide variety of schemas could be used in implementing the invention. The exemplary schema represents a full mixed order-1 context model and includes three principal entities: landmark 70, landmark_statistic 71, and trip_statistic 72. Each entity represents a high level concept. Each entity is represented by a suitable data structure, such as one or more database tables.

Landmark entity 70 contains a fixed and predefined set of records and may be set up in advance by the database administrator beforehand. Each of the records corresponds to a landmark. For example, landmark entity 70 may contain records relating to a large number of landmarks that may be of interest to travelers or other visitors to a particular city.

Landmark entity 70 may contain a record for each and every landmark of one city or more. Each record contains a set of facts about the landmark such as: name, category (e.g. eating establishments, theaters, shopping, religious institutions, medical services, schools, museums, recreational facilities, parks, etc.) and description, address information, and pictures. Landmark categories may be broad, specific, or both. For example, a system according to the invention may include a broad landmark category of “eating establishments” and more specific sub-categories of “formal restaurants”, “family restaurants”, “cafes”, “take out restaurants”, “delicatessens” and so on. The address information represents the location of the landmark and might be presented in one or more of any of multiple formats such as:
a landmark name,
street name;
street name and zip code;
street name and street number;
street name, street number and unit number;
zip code;
GPS coordinates;
street intersection; etc.
   of the landmark.

The landmark entity 70 has a link to itself. This link permits database 10 to express aggregation relationships between landmarks (e.g. where one composite landmark, such as a neighborhood or mall, encompasses a number of other landmarks, such as restaurants that are in the neighborhood or mall).

Landmark_statistic 71 and trip_statistic entities 72 are updated periodically or continuously by application server 40 when system 9 is operating.

Landmark_statistic 71 represents an order-0 fixed model. Landmark_statistic 71 may contain a record for each landmark defined in landmark entity 70. A record in Landmark_statistic 71 may include: landmark score, a value indicating a frequency with which taxi passengers visit the landmark, required attributes for vehicle and driver, and profiles of passengers who have visited the landmark. The landmark score relates to the tendency of taxi passengers to visit the landmark. for example, the landmark score may include one or more of the following:
a value indicating the relative tendency of taxi passengers to visit the landmark as compared to all other landmarks;
a value indicating the relative tendency of taxi passengers to visit the landmark as compared to all other landmarks of the same category as the landmark;
   Recent taxi trips (e.g. taxi trips in recent cycles) may be weighted more heavily in the computation of the landmark score than older trips so that the landmark score tends to represent current traveling patterns of taxi passengers.

Trip statistic entity 72 represents an order-1 fixed model and it contains records of the taxi trip data and their scores. Having a record for each taxi trip can make the data size undesirably large and is potentially inefficient. One solution is to consolidate similar trips as is further explained below.

A record in trip_statistic entity 72 may include some or all of:
a landmark ID of the pickup point,
a landmark ID of the drop off point,
a trip score,
a trip length,
travel time,
taxi fare,
frequency of trip, and
trip type (e.g. delivery, regular taxi trip).
   Taxi Database

Taxi database 50 typically comprises a relational database management system (RDBMS) operating on a suitable computer system. Taxi database 50 includes data tables required to operate taxi company fleets. System 9 may incorporate (at least in the sense that it receives data from) multiple databases 50. For example, system 9 may receive data about taxi trips from multiple taxi companies each of which maintains its own taxi database 50. Each taxi company may run a different dispatching system which might include a different database management system.

A typical schema of a taxi database 50 includes data tables for taxi trips, street addresses, vehicles, drivers, and the profiles of the company's customers. The taxi trip table in database 50 may contain additional data necessary to the taxi company system but irrelevant to the practice of this invention. For example the taxi trip table may contain the name of the call-taker who answers passenger calls and enters the trip detail into the system.

Application Server

Application server 40 is a microprocessor-driven software application that may run on any suitable computer. It is responsible for building and maintaining the landmark_statistic entity 71 and trip_statistic entity 72 in database 10. Application server 40 retrieves details about taxi trips periodically from a plurality of taxi databases 50, processes them, and compiles them into landmark_statistic entity 71 and trip_statistic entity 72.

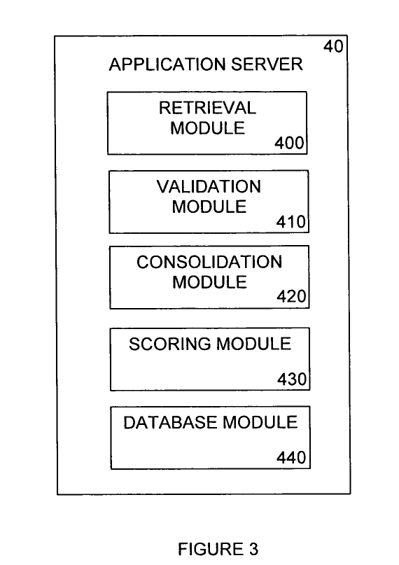

FIG. 3 is a schematic diagram showing the main application modules of application server 40. Application server 40 comprises a retrieval module 400, a validation module 410, a consolidation module 420, a scoring module 430, and database module 440. Although the consolidation module 420 provides certain processing benefits that are described below, it is an optional module. Taxi trips may be forwarded directly to the scoring module 430. When the consolidation module is used, it consolidates two or more similar taxi trips into one record to reduce the amount of data saved into database 10.

Retrieval module 400 is responsible for retrieving taxi trip data from one or more taxi databases 50 on a predetermined frequency or scheduled time, and then making the retrieved data available to validation module 410. Where system 9 operates on a cycle, such as a weekly cycle, as described below, then retrieval module 400 preferably retrieves data from each of the taxi databases 50 at least once per cycle.

Retrieval module 400 has the capability to perform automatic retrieval of data. It has a timer (not shown) to specify the time and frequency of retrieval and a predefined list of addresses of the database(s) 50 (not shown in FIG. 3) from which retrieval module 400 retrieves records of taxi trips.

At the time specified, retrieval module 400 begins the data retrieval process. The data retrieval process may be iterated for several taxi databases 50 or performed in parallel for multiple taxi databases 50. From each taxi database 50, retrieval module 400 extracts data from all the taxi trip records added since the last retrieval time. Retrieval module 400 typically extracts the following fields (if available):
address details of pickup point,
address details of drop off point,
pickup time,
boarding time,
drop off time (to calculate the travel time),
required attributes for vehicle and driver, and
profiles of passengers.
   Retrieval module 400 then makes the retrieved data available to validation module 410.

Retrieval module 400 repeats the data retrieval process when triggered by the timer on a regular basis. In exemplary embodiments, the retrieval process is repeated weekly, every few days or daily.

Validation module 410 validates the taxi trip records, discards any invalid records, converts the valid records into a uniform format and forwards the validated records to consolidation module 420 (or directly to scoring module 430 if a consolidation module is not used).

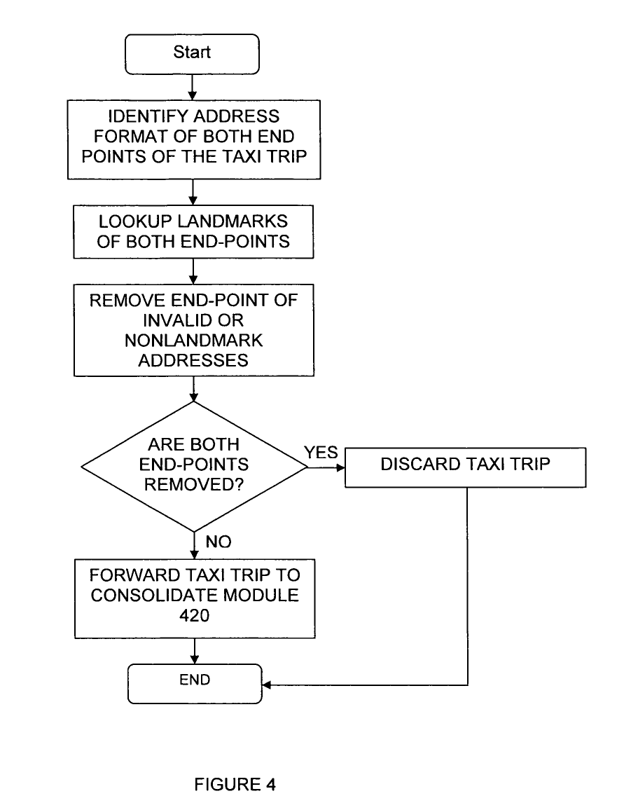

FIG. 4 illustrates the validation process of validation module 410. Validation module 410 validates that at least one of the end points of a taxi trip must refer to a landmark of landmark entity 70. Validation module 410 discards the taxi trips for which neither end point corresponds to a known landmark (i.e. a landmark in landmark entity 70). If a taxi trip has only one non-landmark end point, only that end point is discarded keeping the rest of the record unchanged. Filtering out non-landmark addresses provides a means to protect private or residential places from being listed in response to queries.

Validation module 410 may be capable of validating endpoint address details which are presented in different formats (e.g. street name and street number, landmark name, or raw GPS coordinates). Validation module 410 validates the addresses by looking up in landmark entity 70 the landmark, if any, whose address matches the endpoint address. If the address is raw GPS coordinates, validation module 410 may directly match the GPS coordinates with a landmark. Validation module 410 may optionally perform map matching to estimate the street name and street address corresponding to the GPS coordinates.

Consolidation Module 420 consolidates similar taxi trips to reduce the amount of data saved into database 10. Consolidation module 420 consolidates similar taxi trip records into a single record, and then forwards the consolidated records to scoring module 430. The consolidation process includes finding similar taxi trips that have the same pickup and drop off points and that occurred within a certain time slot, counting the trips, and calculating the average of their travel times. Consolidation module 420 may optionally calculate averages of other variables such as: fares, number of passengers per trip, etc.

The time slots used by consolidation module 420 may be static (fixed) or dynamic (changing, as in response to new empirical data). Each landmark may have a consecutive set of different time slots that cover a reasonable cycle of time. The time slots should be short enough that traveling behavior does not vary significantly across each time slot. Cycle length is the sum of the time slots in the cycle. Preferably the cycle length is some integer number of days, such as one day, one week, one month, or the like. Time slots may be derived from landmark visiting patterns. Maintaining taxi trip statistics for different time slots facilitates various mechanisms for elucidating the highs and lows in the numbers of persons visiting the landmark (common and uncommon times to visit the landmark).

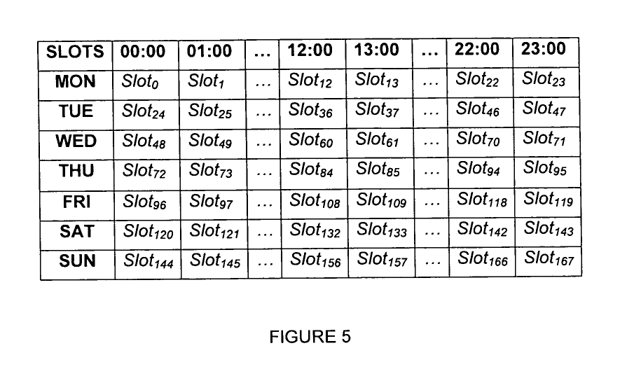

In an exemplary embodiment, the time slots are one-hour intervals and the cycle length is one week as shown in FIG. 5. Therefore each landmark has 168 time slots in each cycle. The one whole week period is divided into a series of consecutive hour one slots starting at midnight of a day of the previous weekend, ending at midnight on the same day of the current weekend. Each time slot has a slot number representing the order of the time slot in the cycle.

Scoring module 430 scores the taxi trips received from consolidation module 420 (or directly from validation module 410 if a consolidation module is not provided). The score represents the tendency of people to take that trip. The scores of the new taxi trips are derived from historical data of the trips and the new data received. Those skilled in the art will recognize that there are many different ways to calculate the scores of taxi trips. The score of a taxi trip may include, for example:
a value representing the relative tendency of taxi passengers to take the taxi trip in question (i.e. a trip between the same endpoints as the taxi trip) as compared to other taxi trips in the system.
a value representing the relative tendency of taxi passengers to take the taxi trip in question (i.e. a trip between the same endpoints as the taxi trip in the same time slot) as compared to other taxi trips in the system for the time slot.
a value representing the relative tendency of taxi passengers to take the taxi trip in question (i.e. a trip between the same endpoints as the taxi trip) as compared to other taxi trips in the system between landmarks belonging to the same categories as the landmarks at the endpoints of the taxi trip in question.

In some embodiments, more recent trips are weighted more heavily than older trips so that the score tends to reflect current travel patterns of taxi passengers more than travel patterns in the more distant past. For example, in some embodiments of the invention, the score for a taxi trip may be computed as follows:
Score=ΣwᵢNᵢ (3)
where the summation is carried out over records of taxi trips from previous cycles, wᵢ is a weighting coefficient, and Nᵢ is the number of trips between the pair of endpoints of interest occurring in the i^{th} cycle or, in the alternative, the corresponding time slot of the i^{th} cycle. The weighting coefficients may be made smaller for older records. For example, weighting coefficients for the four most recent cycles may be 100 while weighting coefficients for older cycles may be weighted with smaller weighting coefficients.

The scores may be normalized in any suitable way. For example, the score for the trip between landmarks of first and second categories which has the highest raw score may be normalized to have a score of 100 or some other convenient number. Raw scores of other trips between landmarks of the same first and second categories may be scaled relative to the highest raw score. For example, in scoring trips which begin at a hotel and end at a museum, a system computes a raw score of 1000 for trips from hotel “A” to museum “A”; a raw score of 750 for trips between hotel “B” and museum “A”; and a raw score of 100 for trips between hotel “C” and museum “A” then the system may normalize these scores so that the trip from hotel “A” to museum “A” has a normalized core of 100; the trip between hotel “B” and museum “A” has a normalized score of 75; and the trip between hotel “C” and museum “A” has a normalized score of 10.

Scoring module 430 optionally also scores the landmarks of the taxi trips received from consolidation module 420 (or from validation module 410). The score for a landmark represents the tendency of people to visit the landmark. New scores for each of the landmarks may be derived from historical data of the landmarks and new taxi data.

The landmark scores are preferably normalized for each category of landmark. For example, each hotel may have a score based upon the number of taxi trips for which that hotel is an endpoint. The hotel which is an endpoint for the most taxi trips may have a score normalized to a convenient value, such as 100. Each of the other hotels will have a normalized score which reflects the number of taxi trips for which that other hotel is an endpoint, relative to the number of taxi trips originating or departing from the hotel which is an endpoint for the most taxi trips. Normalization may be performed separately for landmarks of each category. The normalized scores will therefore all be in the range of 0 to 100.

A landmark may have a number of different normalized scores. for example, a landmark may have scores which are normalized within one or more of:
a sub-category of the landmark;
a category of the landmark;
all landmarks;
all landmarks within a certain geographical area;
etc.

In some embodiments, normalized scores for each trip or landmark are computed using the data for each cycle. Subsequently, a weighted time-averaged-score is computed for the trip or landmark by performing a computation such as:

$$Time\_Averaged \_Score = {\sum }_{i} {w}_{i} {S}_{i} \qquad ( 4 )$$

where the summation is carried out over scores from a number of previous cycles, wᵢ is a weighting coefficient, and Sᵢ is the normalized score for the trip or landmark for the i^{th} cycle (or for a time slot within the cycle). The weighting coefficients can be different for each previous cycle. In some embodiments of the invention, data from more recent cycles is weighted more heavily than data from older cycles. Preferably, this normalization is carried out separately for each time slot in the cycle.

Optionally, factors in addition to the number of times that a trip between certain landmarks occurs in the data can be taken into account in scoring the trip. For example, some additional factors that could be added to the computation of a score for a trip or landmark include:
a number of passengers taking the trip;
a certainty with which the endpoints of taxi trips in the database can be matched with endpoints of the trip in question or with the landmark in question; and,
the like.

Database module 440 updates database 10 with updated scores for taxi trips and landmarks as the scores are computed by scoring module 430. Optionally database module 440 retains historical scores in database 10. The historical scores may be used for trend analysis, scoring and other purposes.

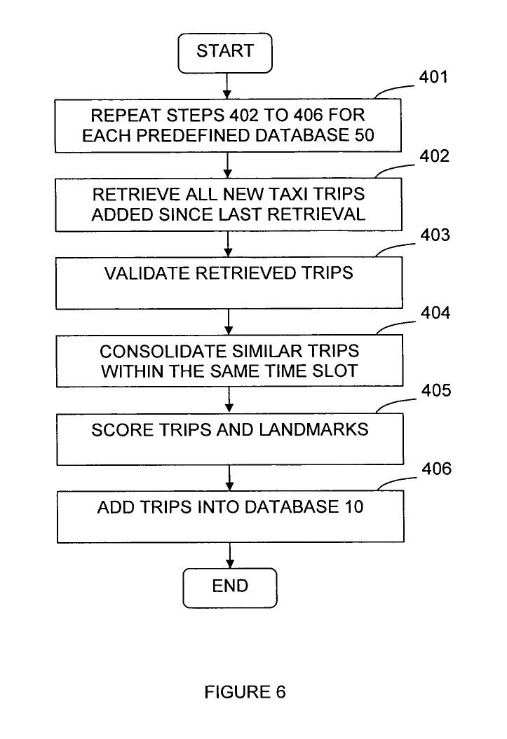

FIG. 6 is a flow diagram which summaries the typical steps taken by application server 400. It maintains a list of addresses of database 50 and periodically retrieves all the new trips added from all of them (401 and 402). Application server 400 validates the trips and standardizes their formats (403); counts and consolidates similar trips occurred in the same time slot (404). Finally, it scores the trips (405) and adds them to database 10 (406).

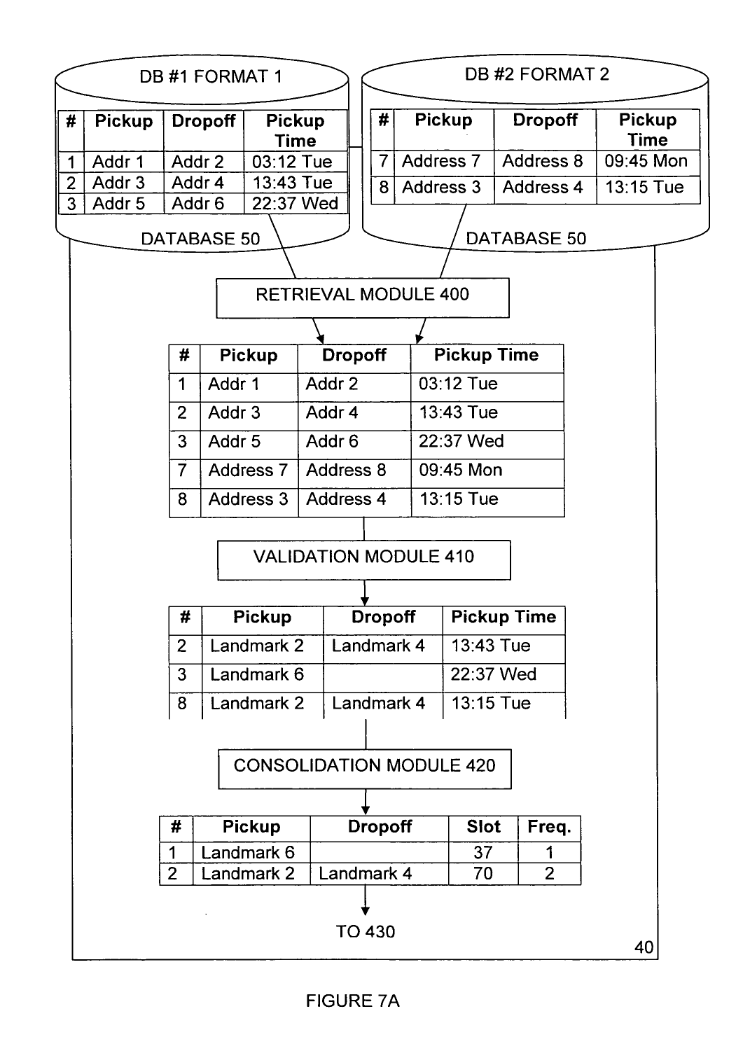

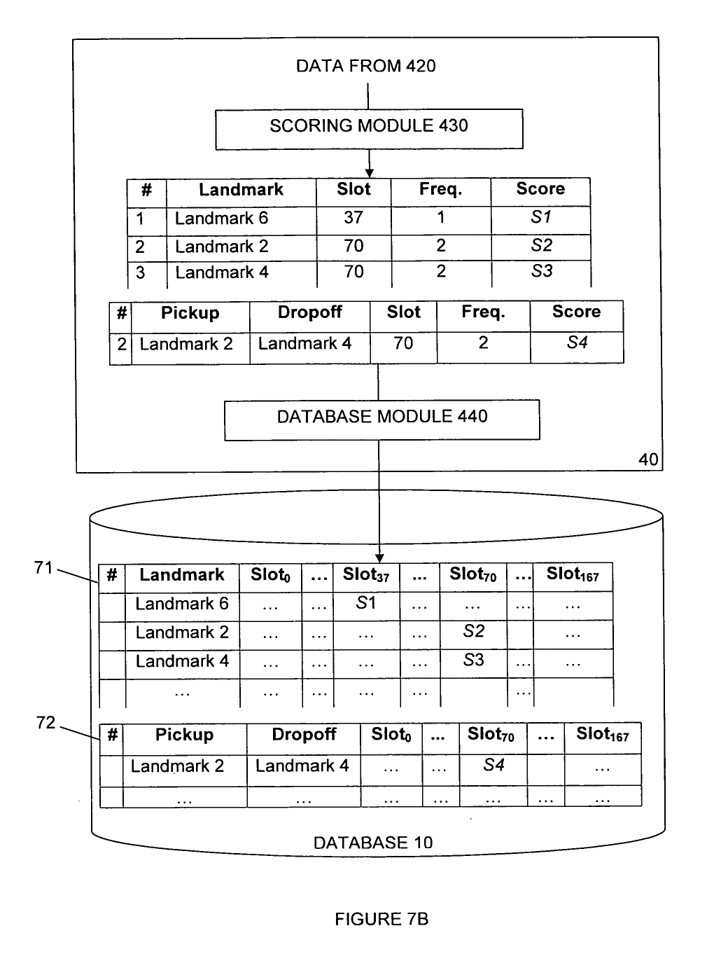

FIGS. 7A and 7B illustrate a dataflow example for exemplary taxi trip data coming from two different databases 50. Records of the taxi trips are retrieved by application server 40. The results are saved in database 10. The first database 50 has three new trips with IDs: 1, 2, and 3 while the second database 50 has two new trips with IDs: 7 and 8. The address format of the two databases is different. In FIGS. 7A and 7B the different address formats are indicated by using “addr” for the first database and “address” for the second database. The number beside each record depicts the location. Thus, “addr n” and “address n” point to the same location, each in its own format. Retrieval module 400 retrieves all the five trips (1, 2, 3, 7, 8). Validation module 410 discards trips 1 and 7 because both their pickup and drop off points do not represent landmarks, and removes the pickup point of trip 3 because it is a non-landmark address. Consolidation module 420 consolidates the similar trips 2 and 8 into a single record and counts their instances since they both fall into the same time slot (e.g. a one-hour interval). Scoring module 430 scores both trips and also computes updated scores for the landmarks in database 10. Finally, Database module updates database 10 with the two new records.

Search Server 20

Search server 20 may comprise a single microprocessor-driven software application or an array of load-balanced microprocessor-driven software applications that may run in any type of computer or number of computers, for resolving search queries to search results. Resolving a search query to a search result may include extracting search terms from an HTTP GET request received from a end-user system 30, performing a “look up” operation in main database 10 to identify information matching the search terms, formatting the search result into a web page in a Hypertext Markup Language (HTML) or Extensible Markup Language (XML) format and returning the search result to the end-user system 30.

Any number of end-user systems 30 may communicate with search server 20, depending on the resources available to the server, such as network connection speed, processing power, etc.

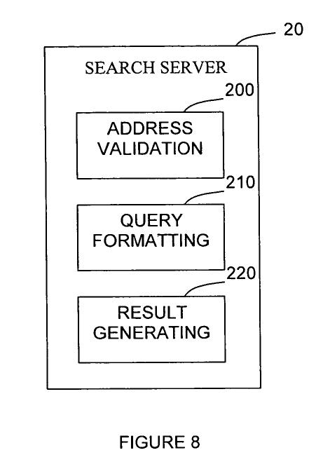

A functional diagram of search server 20 is shown in FIG. 8. Search server 20 performs an address resolve function in response to the address information in front-end query. If address information is available, address validation functionality serves, after receiving the front-end query from end-user system 30, to extract the address information from the front-end query, to parse address information, performs a “lookup up” operation in database 10 using the address information to retrieve all the landmarks that match the address information. Address Validation 200 can support various formats of address information including landmark name, landmark category, street name and street number or unit number, zip code, and GPS coordinates. Address Validation 200 may be error tolerant and may be capable of overcoming many errors due to spelling, or incorrect address formats. Software packages for performing address validation are commercially available.

Search server 20 also performs a query formatting function. Query formatting 210 serves, after determining the landmarks of the address information, to form a back-end query including the landmarks (if any) from address validation 200, landmark categories, targeted cities where the user is interested to find the landmarks, and targeted time period. Query formatting 210 typically forms the back-end query as a SQL query.

Address information in the front-end query affects the format of back-end query. Address information acts as a context for matching taxi trips. The address information may represent the pickup point, destination point, or both of the taxi trips as it can be specified by the end user of the system. If the address information is presented and address validation 200 resolves the information to one landmark or more, the back-end query is formatted to perform lookup in the trip_statistic entity 72 to find the highest scored taxi trips that match the back-end query terms. On the hand, if the address information is not presented, the back-end query is formatted to perform lookup in the landmark_statistic 71 entity to retrieve the highest scored landmarks that match the back-end query terms.

Where the query is directed to a targeted time period that includes more than one time slot, then the scores for taxi trips or landmarks for all of the time slots in the targeted time period may be averaged. The trips or landmarks having the highest average scores may then be selected in response to the query.

Search server 20 also performs a result customization function. Result customization 230 serves, after receiving landmark list, to generate in accordance with the result instruction, a front-end result for display by search client 34 and transmit the front-end result to search client 34. The result instruction may include, for example, an instruction to format the result as a table, chart, or map.

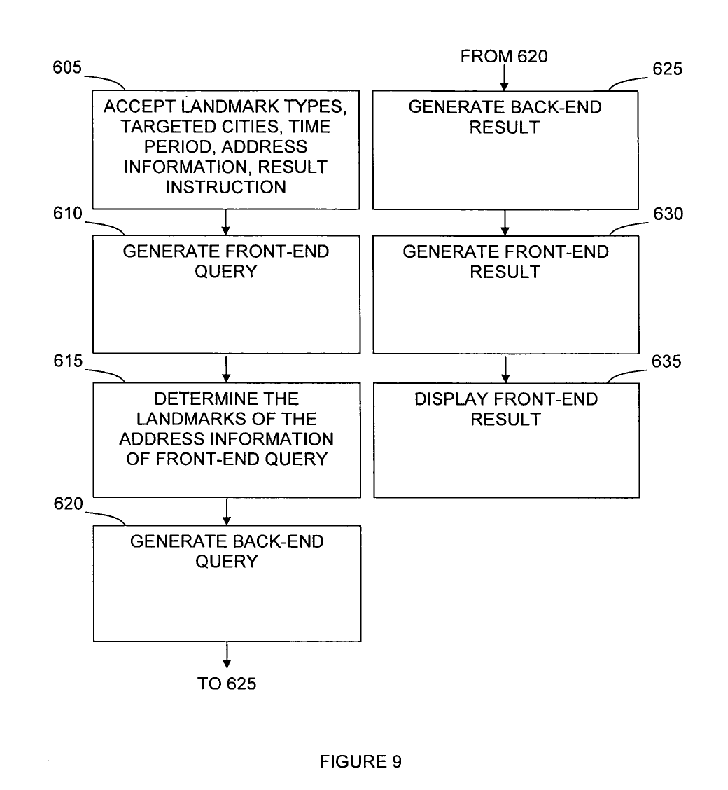

FIG. 9 illustrates a flow diagram of a preferred method for implementing the invention using a database 10, a search server 20, and an end-user system 30 within network architecture 1. On end-user system 30, search client 34 accepts desired landmark categories, targeted cities, address information, targeted time period, and result instruction (605) which may be “keyed in” on user interface 32 or may be implicit in mouse click selections made on user interface 32.

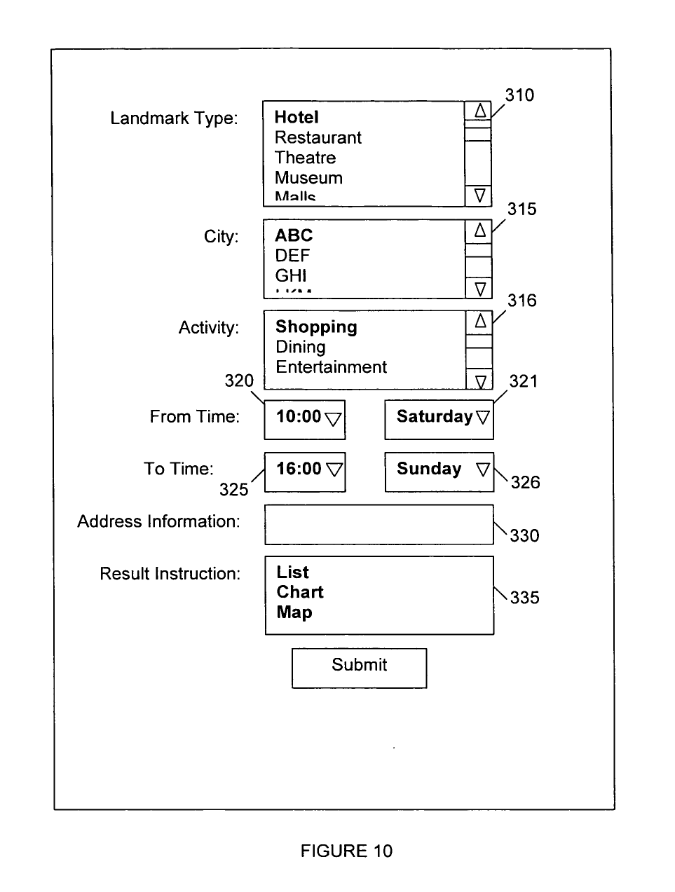

FIG. 10 shows an example of user interface 32. Search client 34 generates a front-end query including the landmark categories, targeted cities, address information, targeted time period, and result instruction and transmits the front-end query to search server 20 (610). Search server 20 resolves the address information and retrieves landmarks that match the address information (615). Search server 20 performs a query formatting and forms a back-end query in accordance to the result instruction and the result of step 615; and transmits the back-end query to database 10 (620).

Database 10 resolves the back-end query to a back-end result including and transmits the back-end result to search server 20 (625). Search server 20 generates a front-end result in accordance with the result instruction for display by search client 34 and transmits the front-end result to end-user station 30 (630). On end-user station 30, search client 34 facilitates display of the front-end result on user interface 32 (635).

### APPLICATION EXAMPLES

The following scenarios illustrate some examples of ways in which a system according to the invention may be used. A system according to the invention may be used for planning many aspects of a trip to a strange city. A system according to the invention may also be used by locals.

### Example #1

Fred wishes to visit another city and needs to find a hotel in the other city. Fred uses a system according to the invention to search for hotels in the other city. The system returns a list of hotels ranked in order of their scores. The scores are derived from taxi trip data as described above. Fred reviews the hotels and selects a hotel from near the top of the list because he is interested in staying at a popular hotel.

### Example #2

Suppose, for purposes of illustration, that Fred wants to spend a few-days of vacation in city ABC. Fred starts his travel plan by looking for accommodation in city ABC. Fred, using user interface 32 shown in FIG. 10, selects “hotel” in landmark category list (310), ABC in city (315), “shopping” in activity list (316) and result instructions as table, chart, and map (335). The end-user system accepts the query. Search client 34 generates a front-end query including the landmark category (hotel), targeted city (ABC), targeted activity (“shopping”) and result instruction (table, chart, and map) (610) and transmits the front-end query to search server 20.

Search server 20 forms a back-end query to retrieve the highest-scored hotels from which taxi passengers most regularly visit malls (or other landmarks associated with shopping) in city ABC and transmits the back-end query to database 10 (620). Database 10 resolves the back-end query to a list of hotels and their properties and transmits the result to search server 20 (625).

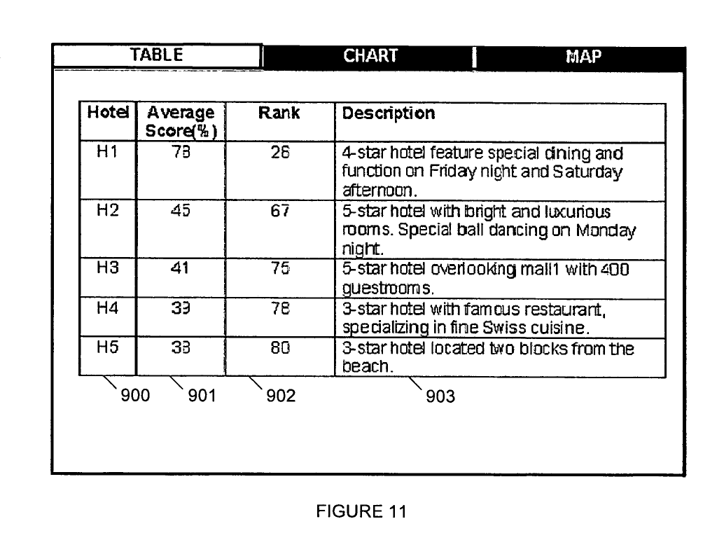

Search server 20 generates table, chart, and map views of the results received from database 10 and transmits the results to end-user station 30 (630). On end-user station 30, search client 34 facilitates display of the front-end result on user interface 32 (635). The results are displayed in a new window. FIGS. 11-13 depict exemplary GUI windows for table, chart, and map views of the search results respectively.

FIG. 11 shows the table view of the result which is a list of five hotels. Each is arranged in a separate row that contains the hotel name (900), the average score (901) (which could be averaged over a target time period, for example and may be normalized), the landmark rank (902) (which could be a rank within the category or sub-category to which the landmark belongs or the rank of the landmark in comparison to all other landmarks, for example), and general description of the hotel (903). The table might also include a text or graphical analysis of the most common periods during which people travel to shopping destinations from the hotel or travel to the hotel from shopping destinations. The table also might include a text or graphical analysis of the average rate at which taxi customers arrive at the hotel as a function of time.

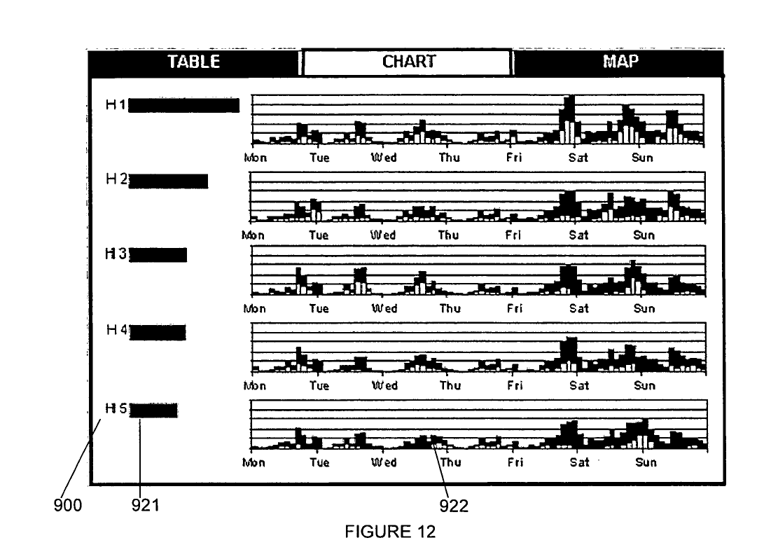

FIG. 12 shows the score average of the landmark (the hotel in this example) graphically (921). Bar plot (922) shows the time distribution of the score of the hotel. The x axis is a temporal scale of one week divided into 84 time slots of two hours each. Stacked bar Iin the figure is the landmark score for time slot I (for I=1 to 84) compared with maximum score of all the hotels for the same time slot. An insight into the best time to travel to those landmarks may be obtained by visual examination of bar plot 922.

The peaks show the most common time to visit the landmarks. Fred may be the kind of person who likes to go to a landmark at the most common time; or he may be the kind of person who shuns the common time and likes to travel at quiet times. Regardless, it is the presence of the score relationship with time which allows Fred to make an intelligent decision.

It will be appreciated that other time series plots of other trip types can be displayed in FIG. 12 to compare the frequencies with which taxi travelers are traveling to a hotel with other activities such as going to a restaurant or a theater from the hotel. Fred may obtain an impression of the relative intensity of their trip occurrences and adjust his time of traveling to the hotel accordingly.

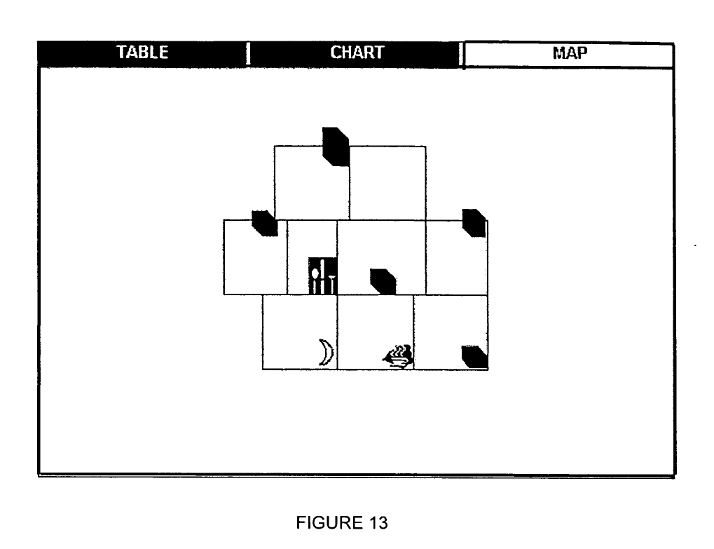

FIG. 13. shows a portion of a map that indicates the five hotels located by Fred's search. The hotels are represented as rectangles having heights which vary as a function of the scores. The shape and the color express the landmark category (beige rectangle for hotels, white crescent for medical, etc). The map helps the user to understand the relative locations of landmarks and their proximity to other landmarks.

Fred examines the three views and finds the description of hotel H1 matches his interests and the most common time for arriving at the hotel H1 coincides with his desirable arrival time. Fred considers H1 to be his best choice among the hotels located by the search.

### Example #3

Fred continues his tour planning. Fred wishes to find the most common restaurant that the guests of hotel H1 go to for lunch or dinner. Fred selects restaurant in landmark categories (310), enters the address of hotel H1 in the address information (330) to use as a context for his search, and requests results as table, chart, and map (335).

The system generates a query which searches for the restaurants to which people most often travel by cab from hotel H1. The system displays a list of 30 restaurants. The first restaurant R1 scores 80% and ranks 108th in the list of all landmarks. Restaurant R1 might have special deal for H1 hotel guests. Fred might meet other guests of his hotel at restaurant R1.

Furthermore, Fred examines the bar plot (922) of R1 to find the common time that people go to restaurant R1. Fred finds that 12 p.m. to 2 p.m. on Tuesdays, and 6 p.m. to 8 p.m. on Saturdays are common periods. R1 may offer special menu, offer special discounts, or provide special attractions during those periods. Fred decides to try eating at R1 and takes a note of the Tuesday period.

### Example #4

Fred is downtown in a strange city. He is hungry. He locates a kiosk which provides an end-user terminal for a system according to the invention. He selects “restaurants” as a landmark category to search for, the kiosk is configured to default to supplying its own location as context information.

The system retrieves a list of restaurants and then ranks the restaurants based upon the frequency with which taxi passengers travel to the restaurants from locations nearby the kiosk.

The kiosk displays a bar chart for each of the restaurants. The bar chart indicates the time slots during which most taxi passengers visit each of the restaurants. It is the middle of the afternoon. Fred would rather eat at a restaurant that is lively in the mid afternoon. Fred selects a restaurant for which the bar chart indicates that there is significant traffic of taxi passengers in the mid-afternoon.

The kiosk optionally includes a control that Fred can operate to summon a cab to take him to the selected restaurant.

### Example #5

A system may permit a user to conduct a search for the restaurants and entertainment-related landmarks for which taxi patrons most frequently take a first taxi trip from a given location to the restaurant and a second taxi trip from the restaurant to the entertainment-related location. As another example, a user may search for restaurants commonly visited by patrons of a hotel. After selecting a restaurant from the resulting set of restaurants the user might query the system to see where do taxi patrons who have traveled to the restaurant from the hotel typically go to after visiting the restaurant. This may produce a list of entertainment-related landmarks which are convenient to go to from the restaurant.

### Example #6

Jill wants to go out to an entertainment venue the next day, Thursday. She will have three hours, from 5:00 p.m. until 8:00 p.m. to spend at the entertainment venue. Jill uses her home computer to access a system according to the invention by way of the internet. Jill selects “entertainment” and 5:00 p.m. to 8:00 p.m. Thursday on a web form produced by the system. The system returns a list of entertainment venues ranked according to their average scores for the time slots in the period from 5:00 p.m. to 8:00 p.m. on Thursday. The entertainment venues may include theaters, bars, cinemas, nightclubs, and the like.

### Example #7

Siobhan is travelling on business. She needs to book a hotel from which she can easily reach the airport in a city she will be visiting. She will have an early-morning flight the next day. Siobahn queries the system for hotels from which people most commonly travel to the airport between the hours of 4 a.m. and 6 a.m. Siobhan requests a map view of the results. From the map view she sees that there are a number of hotels from which the airport can be conveniently reached. She selects a popular hotel from the list produced by the system that is also reasonably convenient to her other business in the city.

Alternative Architecture

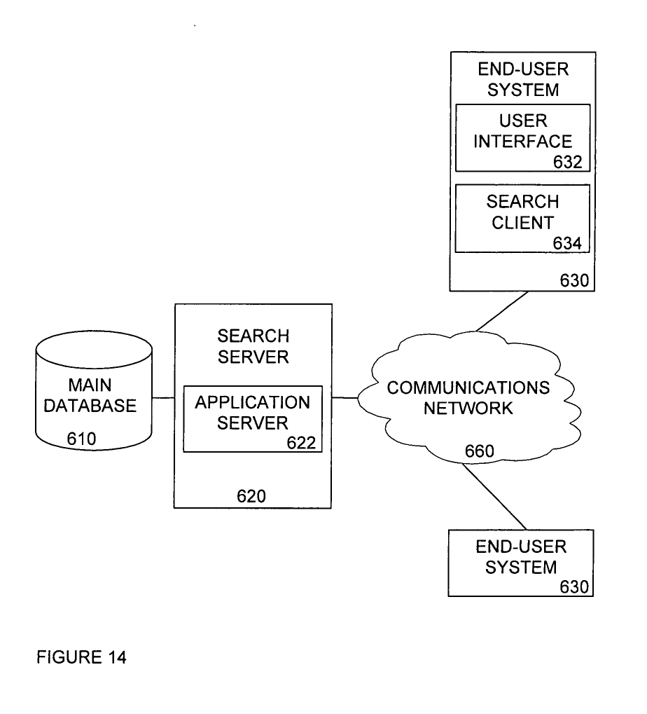

FIG. 14 shows a system according to a second embodiment of the invention in which a network architecture 61 includes a taxi database 610, search server 620, and an end-user system 630. In the second preferred embodiment, main database schema and taxi database schema are co-located at taxi database 620. Application server 622 is co-located at search server 620.

Application server 622 comprises a retrieval module 6400, validation module 6410, consolidation module 6420, a scoring module 6430, and database module 6440, which are operatively identical to their counterparts in a retrieval module 400, a validation module 410, a consolidation module 420, a scoring module 430, and database module 440 of the first preferred embodiment, except job retrieval module 6400 read only from database 610.

Taxi database 610 is identical to its counterpart taxi database 50, except it also contains the schema of database 10.

Search server 620 and end-user system 630 are operatively similar to their counterparts search server 20 and end-user system 30 described above in relation to the first preferred embodiment.

In some embodiments of the invention, extra information other than taxi trip information is used in deriving a score for a landmark. The extra information may comprise any information which bears a reasonable relationship to the popularity of a landmark. For example, the extra information may comprise one or more of:
sales information representing a number of sales in a given period (the sales information may comprise e.g. a number of parties who dine at a restaurant; a number of persons who pay a cover charge at a nightclub; a number of entrance tickets sold to a sporting event; a number of tickets sold for a movie or performance; or the like);
sales information representing a dollar volume of sales in a given period;
information that indirectly indicates the popularity of a landmark such as one or more of: a number of parties who use or revenues from valet parking; parking machines; phone booths; games machines; snack or pop machines or the like.
   Sales information may be derived from credit card information for a business that operates a landmark.

The extra information may be weighted with a suitable weighing factor and combined with taxi trip data to obtain a score for a landmark that is based in part on the taxi trip information and in part on the extra information. Where a system uses multiple different types of extra information then different weighing factors may be provided for the different types of extra information.

In some alternative embodiments of the invention, landmark scores are based entirely on the extra information and are not based on information about taxi trips.

An operator of a system according to the invention may derive revenue from the system, if desired, in any suitable ways. A few examples are:
The system may be configured to display advertisements with the search results. The system may include a database of advertisements. When it executes a search for a user the system may also search the database of advertisements for advertisements that are germane to the user's search. The system may display such advertisements. Parties may pay to have such advertisements available in the system.
Operators of landmarks may pay to have enhanced descriptions of the landmarks included in the system where they can be accessed by users of the system.
Taxi companies may pay for referrals obtained, for example, as described in Example #4 above.
The system may be configured to keep track of instances when users “click through” to obtain more information about a landmark. Operators of landmarks may be willing to pay for the advertising opportunity this provides.
and so on.

As will be apparent to those skilled in the art in the light of the foregoing disclosure, many alterations and modifications are possible in the practice of this invention without departing from the spirit or scope thereof. For example:
It is not necessary that landmarks of the same type be scored in the same way. Different scoring formulae may be used for landmarks of different types.
   Accordingly, the scope of the invention is to be construed in accordance with the substance defined by the following claims.

1. A method for operating an automated system for providing information about landmarks, the method comprising:
providing statistical information about relationships between a plurality of landmarks, the statistical information derived at least in part from records of taxi trips originating, ending, or both originating and ending at landmarks of the plurality of landmarks;
receiving a request for a search of landmarks matching a set of search criteria;
in response to the request, retrieving a set of landmarks matching the search criteria; and,
ranking the set of landmarks retrieved by the search at least in part on the basis of the statistical information.

2. A method according to claim 1 wherein the request for the search includes context information and ranking the set of landmarks is based on both the statistical information and the context information.

3. A method according to claim 2 wherein the context information comprises an address and ranking the set of landmarks comprises ranking the landmarks in order of a historical frequency of taxi trips between the address and the landmarks in the set of landmarks.

4. A method according to claim 2 wherein the context information comprises an identification of an activity type, some of the plurality of landmarks are associated with the activity type, and ranking the set of landmarks comprises ranking the landmarks in order of a historical frequency of taxi trips between landmarks associated with the activity and the landmarks in the set of landmarks.

5. A method according to claim 1 wherein providing the statistical information comprises obtaining records of taxi trips from a plurality of taxi databases.

6. A method according to claim 5 wherein the plurality of taxi databases include a plurality of record formats and the method comprises placing the records of the taxi trips into a common format before deriving the statistical information from the records.

7. A method according to claim 6 comprising identifying groups of similar records in the records of the taxi trips and consolidating the records of the taxi trips by replacing each group of similar records with a single record.

8. A method according to claim 1 wherein the statistical information includes an order-0 finite context model.

9. A method according to claim 8 wherein the statistical information includes an order-1 finite context model.

10. A method according to claim 1 wherein the statistical information includes both an order-1 finite-context model and an order-0 finite context model.

11. A method according to claim 1 wherein the statistical information comprises statistical information for each of a plurality of time slots and the method comprises, for one or more of the landmarks in the set of landmarks, displaying to a user a graphical indication of a historical frequency of taxi trips having an endpoint at the landmark as a function of time slot.

12. A method according to claim 11 wherein each time slot corresponds to a period of 3 hours or less.

13. A method according to claim 11 wherein the graphical indication includes a first part indicating a historical frequency of taxi trips having a pickup point at the landmark and a second part indicating a historical frequency of taxi trips having a drop off point at the landmark.

14. A method according to claim 11 wherein the graphical indication comprises a bar chart.

15. A method according to claim 1 wherein retrieving the set of landmarks matching the search criteria comprises identifying landmarks at endpoints of taxi trips from one or more locations.

16. A method according to claim 15 wherein the one or more locations are locations of other landmarks having a specified category.

17. A method according to claim 15 wherein the one or more locations comprises an address.

18. A method according to claim 17 wherein receiving the request comprises accepting the request from a user of an end-user computer system and the address is a location of the end-user computer system.

19. A method according to claim 1 wherein the plurality of landmarks include landmarks of each of a plurality of categories selected from the group consisting of restaurants, bars, theaters, museums, hotels, motels, shopping malls, stores, buildings, neighborhoods, districts, zoos, arenas, sports venues, tourist attractions, parks, beaches, and places of worship.

20. A method according to claim 1 wherein ranking the set of landmarks retrieved by the search comprises ranking the landmarks based on the statistical information and on sales information for the landmarks.

21. A computer program product comprising a medium carrying computer-readable instructions which, when executed by a computer system, cause the computer system to implement a method according to claim 1.

22. A method for automatically retrieving a set of landmarks of interest to a user, the method comprising:
receiving from the user type information identifying a category of landmark of interest and context information directly or indirectly specifying at least one location;
retrieving from a database a set of landmarks of the category indicated by the type information; and,
ranking the landmarks of the set of landmarks based on the frequency with which taxi passengers have historically traveled between the at least one location of the context information and the landmarks of the set of landmarks.

23. A method according to claim 22 wherein the context information comprises a location of a landmark.

24. A method according to claim 22 wherein receiving the type and context information comprises accepting input from a user of an end-user computer system and the context information comprises a location of the end-user computer system.

25. A method according to claim 24 wherein the plurality of landmarks include landmarks of each of a plurality of categories selected from the group consisting of restaurants, bars, theaters, museums, hotels, motels, shopping malls, stores, buildings, neighborhoods, districts, zoos, arenas, sports venues, tourist attractions, parks, beaches, and places of worship.

26. A computer program product comprising a medium carrying computer-readable instructions which, when executed by a computer system, cause the computer system to implement a method according to claim 22.

27. A computerized landmark information system comprising:
a data store storing information about a plurality of landmarks and statistical information about relationships between the plurality of landmarks, the statistical information derived at least in part from records of taxi trips originating, ending, or both originating and ending at landmarks of the plurality of landmarks;
a search engine for conducting searches for sets of landmarks of the plurality of landmarks which match search criteria; and,
means for ranking sets of landmarks retrieved by the search engine based at least in part on the statistical information.
